(19) United States
(12) Patent Application Publication
(10) Pub. No.: US 2014/0101060 A1
(43) Pub. Date: Apr. 10, 2014

(54) ASSET TITLER

(71) Applicant: BANK OF AMERICA CORPORATION, Charlotte, NC (US)

(72) Inventors: Matthew A. Calman, Charlotte, NC (US); Carrie A. Hanson, Charlotte, NC (US); John M. Rees, Charlotte, NC (US); Nancy G. Talarico, Matthews, NC (US)

(73) Assignee: Bank of America Corporation, Charlotte, NC (US)

(21) Appl. No.: 13/647,024

(22) Filed: Oct. 8, 2012

(51) Int. Cl. G06Q 50/18

(52) U.S. Cl. 705/312

(57) ABSTRACT

According to one embodiment, a memory may store information associated with an asset. A processor communicatively coupled to the memory may receive a request to transfer the asset upon the occurrence of an event. The processor may further determine at least one of an appropriate titling and an appropriate beneficiary designation of the asset based at least in part upon the asset and the event and apply at least one of the appropriate titling and the appropriate beneficiary designation to the asset.

### TECHNICAL FIELD

This disclosure relates generally to an apparatus that titles assets.

### BACKGROUND

Assets need to be titled properly in order for owners to have the proper ownership rights to the asset, and for the asset to flow to the proper individuals and entities when owners pass away. However, owners often are not aware of the property laws and estate laws that affect the titling of their assets, which results in improper ownership rights and beneficiary designations.

### SUMMARY OF THE DISCLOSURE

According to one embodiment, a memory may store information associated with an asset. A processor communicatively coupled to the memory may receive a request to transfer the asset upon the occurrence of an event. The processor may further determine at least one of an appropriate titling and an appropriate beneficiary designation of the asset based at least in part upon the asset and the event and apply at least one of the appropriate titling and the appropriate beneficiary designation to the asset.

According to another embodiment, one or more computer-readable non-transitory storage media may embody software that is operable when executed to present, on a display, a question associated with a transfer of an asset and communicate an answer to the question. The software may be further operable to receive, in response to communicating the answer, a message indicating at least one of an appropriate titling and an appropriate beneficiary designation based at least in part upon the answer and present, on the display, at least one of the appropriate titling and the appropriate beneficiary designation.

Certain embodiments may provide one or more technical advantages. A technical advantage of one embodiment includes providing an electronic interface for owners to properly title their assets based on responses to basic questions that use easily understood terminology. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates a system for titling assets;

FIG. 2 illustrates a device of the system of FIG. 1 that aids in the titling of assets;

FIG. 3 illustrates a device of the system of FIG. 1 that aids in the titling of assets;

FIG. 4 illustrates a device of the system of FIG. 1 that aids in the titling of assets;

FIG. 5 illustrates a device of the system of FIG. 1 that aids in the titling of assets; and

FIG. 6 is a flowchart illustrating a method of titling assets.

### DETAILED DESCRIPTION

This disclosure describes a system for titling assets. Assets should be properly titled in order for owners of the assets to have proper ownership rights and for the assets to flow to the proper individuals and entities when the owners pass away. The system aids users in determining the proper titling and/or beneficiary designations for their assets.

For example, a user may have a savings account and the user may be getting married. After the marriage the user may want the spouse to also have access to the savings account. However, in the event that the user passes away, the user may desire for the account to transfer to a parent. In order to bring about this outcome, the user may change the titling and beneficiary designations on the savings account. However, the user may not understand all the terminology and the processes through which the account can be set up so that the spouse has access but the parent inherits the account upon the user's passing.

The system provides the user with an electronic interface through which the user can specify the desired ownership and beneficiaries associated with the savings account. The interface may present questions to the user that are easy for the user to understand. For example, the system may ask the user whether the user wants to allow someone else to have access to the account and what kind of access that person should have. As another example, the system may ask the user to whom the account should transfer if the user passes away. The user may supply responses to these questions and the system may use these responses to determine the appropriate titling and/or beneficiary designations for the account. For example, based on the user's response, the system may determine that the spouse should be designated as an owner of the account conditioned upon the life of the user and that the parent should be designated as a primary beneficiary of the account.

The system may further determine whether the user has any other assets. If the user has other assets, the system may ask whether the same titling and beneficiary designations should be extended to the other assets. If the user wishes to extend the titling and beneficiary designations to the other assets, then the system may apply the same titling and beneficiary designations to those other assets.

In particular embodiments, the system aids the user to properly title assets by asking easily understood questions. The user may properly title the assets and properly designate beneficiaries even though the user may not be savvy in property law or estate law.

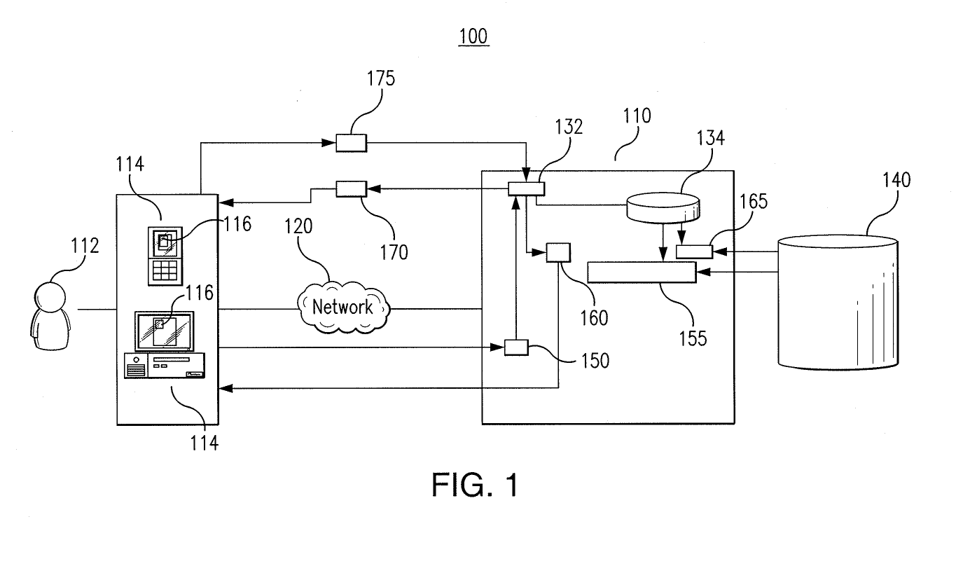

FIG. 1 illustrates a system 100 for titling assets. System 100 may include a device 114, a server 110, and a database 140. The device 114 may be communicatively coupled to the server 110 through network 120. The database 140 may be communicatively coupled to the server 110. Although not illustrated, the database 140 may be communicatively coupled to the server 110 through network 120. In particular embodiments, system 100 may aid a user 112 to properly title and designate beneficiaries for an asset. The user 112 may provide answers to questions that include easily understood terminology and system 100 may use those answers to determine the appropriate titling and/or beneficiary designations for the asset.

User 112 may use device 114 to interact with system 100. Device 114 may be associated with user 112. For example, device 114 may be user's 112 cell phone, tablet, personal computer, and/or laptop. In particular embodiments, user 112 may use device 114 to answer questions related to titling and/or designating beneficiaries for an asset. For example, user 112 may use device 114 to answer the question: “To whom should the asset be transferred upon your passing?” Device 114 may further provide answer choices from which user 112 can make a selection. For example, in response to the question, “To whom should the asset be transferred upon your passing,” device 114 may present answer choices such as “my spouse,” “my parent,” and/or “my sibling.” User 112 may select one of these answer choices and device 114 may communicate that answer choice to system 100. System 100 may then use that answer choice to determine the appropriate titling and/or beneficiary designation for the asset.

Device 114 may be a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 100. Device 114 may also include a user interface, such as a display, a touchscreen, a microphone, keypad, or other appropriate terminal equipment usable by user 112.

Device 114 may execute an application 116. In particular embodiments, device 114 may include a memory and a processor operable to store and to execute application 116. Device 114 may execute application 116 to perform the functions described herein. For example, when executed, application 116 may present on a display of device 114 the questions and answer choices that user 112 may select to communicate his desired titling and/or beneficiary designations. As another example, application 116 may communicate user's 112 selected answer choice to system 100.

Device 114 may be communicatively coupled to network 120. Network 120 may be configured to route network traffic to and from device 114, server 110, and database 140. This disclosure contemplates any suitable network 120 operable to facilitate communication between the components of system 100. Network 120 may include any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Server 110 may be communicatively coupled to network 120. Server 110 may determine the appropriate titling and/or beneficiary designations for assets based on responses communicated by device 114. For example, user 112 may select an answer choice indicating that his spouse should be the only person who owns the asset after the user 112 passes away. Based on that response, server 110 may determine that user's 112 spouse should be a primary beneficiary on the asset. Server 110 may include a memory 134 and a processor 132 communicatively coupled to the memory 134 that perform the functions described herein.

Memory 134 may store information associated with user 112 and information associated with assets. For example, memory 134 may store the names and relationships of people associated with user 112 such as a spouse of user 112 and a parent of user 112. As another example, memory 134 may store information about savings accounts, checking accounts, and other personal assets of user 112 such as a home or a car. In particular embodiments, database 140 may also store this information. Server 110 may load this information from database 140 and store the information in memory 134. Server 110 may also store this information in database 140. If the information changes, server 110 may write over the information stored in database 140 and/or memory 134 with the changed information.

Memory 134 may store, either permanently or temporarily, data, operational software, or other information for processor 132. Memory 134 may include any one or a combination of volatile or non-volatile local or remote devices suitable for storing information. For example, memory 134 may include random access memory (RAM), read only memory (ROM), magnetic storage devices, optical storage devices, or any other suitable information storage device or a combination of these devices.

Processor 132 may perform the communication and determining functions of server 110. For example, processor 132 may communicate questions and answer choices to device 114 and receive responses to those questions and answer choices from device 114. Based on those responses, processor 132 may determine the appropriate titling and/or beneficiary designations for an asset. In particular embodiments, processor 132 may determine a plurality of titling and/or beneficiary designations for an asset. Processor 132 may communicate the appropriate titling and beneficiary designations to device 114. In embodiments where processor 132 determines multiple appropriate titling and beneficiary designations, processor 132 may receive a selected titling and/or beneficiary designation from device 114. Processor 132 may then apply the selected or the appropriate titling and/or beneficiary designation to an asset.

In particular embodiments, processor 132 may extend the selected and/or the appropriate titling and/or beneficiary designation to other assets associated with user 112. For example, after processor 132 has designated user's 112 spouse as the primary beneficiary on user's 112 savings account, processor 132 may determine that user 112 also has a checking account. Processor 132 may then ask user 112 if user 112 wants to designate his spouse as the primary beneficiary on the checking account. If user 112 agrees to extend the beneficiary designation to the checking account, then processor 132 may designate the spouse as the primary beneficiary on the checking account.

Processor 132 may control the operation and administration of server 110 by processing information received from network 120 and memory 134. Processor 132 may include any hardware and/or software that operates to control and process information. Processor 132 may be a programmable logic device, a microcontroller, a microprocessor, any suitable processing device, or any suitable combination of the preceding.

In operation, user 112 may use device 114 to interact with server 110 in order to appropriately title and/or designate beneficiaries for an asset. For example, user 112 may desire to appropriately title and/or designate beneficiaries for a savings account. User 112 may use device 114 to indicate that he desires to change the titling and/or the beneficiary designations on the savings account. In response, device 114 may communicate an asset request 175 to server 110. The asset request 175 may include an identifier for user 112, such as a user name, an identifier for the savings account, such as an account number and an account type, and a request type indicating that user 112 desires to set the title and/or beneficiary designation for the savings account. Processor 132 may use the information included in asset request 175 to determine which user 112, device 114, asset is being requested, and what type of request is being made.

Based on asset request 175, processor 132 may retrieve user information 155 and asset information 165 from memory 134. In particular embodiments, processor 132 may retrieve user information 155 and asset information 165 from database 140. User information 155 may include any suitable information associated with user 112. For example, user information 155 may include a name, birthday, social security number, and any other suitable information associated with user 112. In particular embodiments, user information 155 may further include information about individuals associated with user 112. For example, user information 155 may include the name and age of a spouse, parent, or child of user 112.

Asset information 165 may include information about assets associated with user 112. For example, asset information 165 may include an account number, asset type, and value associated with an asset, such as a savings account associated with user 112. In particular embodiments, asset information 165 may include information of unrequested assets associated with user 112. For example, even though asset request 175 includes information for the savings account of user 112, asset information 165 may include information about a checking account, a home, and/or a car of user 112.

Processor 132 may use user information 155 and asset information 165 to determine whether user 112 is authorized to change the titling and/or beneficiary designation on the requested asset. For example, asset information 165 may show that the savings account is held jointly by the user's 112 spouse. Processor 132 may use that information to determine that user 112 is not authorized to change the beneficiary designation on the savings account without the spouse's approval.

If user 112 is authorized to change the titling and/or the beneficiary designation of the requested asset, processor 132 may use user information 155 and asset information 165 to determine which questions and answer choices to communicate to device 114 in order to determine the appropriate titling and/or beneficiary designation for the requested asset. For example, asset request 175 may indicate that user 112 desires to change the beneficiary designation on a savings account. Processor 132 may determine, based on that request, that an appropriate question to ask user 112 is: “To whom should the savings account be transferred upon your passing?” Processor 132 may then use user information 155 to determine answer choices for the question. For example, user information 155 may indicate that user 112 has a spouse and two children. Processor 132 may use that information to craft answer choices that include the user's 112 spouse and children, such as for example, “my spouse,” “my oldest child,” and “my youngest child.” In particular embodiments, processor 132 may use user information 155 to determine the names of the people indicated by the answer choices. Processor 132 may then communicate answer choices that include the names of the people. After processor 132 has determined questions and answer choices, processor 132 may communicate a message 170 to device 114 that includes the questions and answer choices.

Device 114 may receive the message 170 and display the questions and the answer choices to user 112. For example, device 114 may receive message 170 and display the question “To whom should the savings account be transferred upon your passing?” and the answer choices: “my spouse,” “my oldest child,” and “my youngest child.” In particular embodiments, message 170 may include a plurality of questions and respective answer choices that may be selected in order to determine the appropriate titling and/or beneficiary designations for the asset.

User 112 may use device 114 to select the desired answer choices to the questions posed by server 110. For example, user 112 may use device 114 to select the answer choice “my spouse” as an answer to the question “To whom should the savings account be transferred upon your passing?” After user 112 selects an answer choice, device 114 may communicate a selection 150 to server 110. Selection 150 may include information associated with user 112, such as a username, and the selected answer choice. Processor 132 may receive selection 150 and determine the answer choice selected by user 112 based on selection 150. For example, based on selection 150, processor 132 may determine that user 112 selected the answer choice “my spouse” to the question “to whom should the savings account be transferred upon your passing.”

Processor 132 may use selection 150 to determine the appropriate titling and/or beneficiary designation for an asset. For example, if selection 150 indicates that user 112 wants his spouse to have access to the savings account currently, and to own the savings account upon the user's 112 passing, processor 132 may determine that the spouse should be added as a joint owner of the savings account. As another example, if selection 150 indicates that user 112 does not want his spouse to have access to the account currently but wants the spouse to own the account after the user's 112 passing, then processor 132 may determine that the spouse should be added as a primary beneficiary of the savings account.

In particular embodiments, processor 132 may also use asset information 165 to determine the appropriate titling and/or beneficiary designation. For example, if selection 150 indicates that user 112 wants his child to inherit the entirety of the savings account upon the user's 112 passing but asset information 165 indicates that user's 112 spouse is currently the primary beneficiary, then processor 132 may determine that the spouse should be removed as a beneficiary and that the child should be added at the primary beneficiary on the savings account.

Processor 132 may communicate a message 160 indicating the appropriate titling and/or beneficiary designation to device 114. Device 114 may then inform user 112 of the appropriate titling and/or beneficiary designation. In particular embodiments, device 114 may allow the user 112 to confirm the appropriate titling and/or beneficiary designation before it is applied to the asset. For example, message 160 may indicate that processor 132 has determined that the user's 112 spouse should be added as a joint owner on the savings account. Device 114 may ask user 112 to confirm that his spouse should be added as a joint owner before processor 132 will apply the new ownership to the savings account.

In particular embodiments, message 160 may include a plurality of appropriate titles and/or beneficiary designations. For example, processor 132 may determine that adding the user's 112 spouse as a joint owner, an owner-in-common, or as a primary beneficiary will meet the desires of user 112. Processor 132 may communicate these appropriate titling and/or beneficiary designation options in message 160. In particular embodiments, system 100 may further explain the differences amongst the communicated titling and/or beneficiary designation options. In response to receiving message 160, device 114 may ask user 112 to select which titling and/or beneficiary designation option the user 112 desires. After user 112 selects a desire titling and/or beneficiary designation option, processor 132 may apply the selected titling and/or beneficiary designation to the asset.

In particular embodiments, processor 132 may extend the titling and/or beneficiary designation to other assets associated with user 112. For example, based on user information 155 and/or asset information 165, processor 132 may determine that user 112 also owns a checking account, and that the title and/or beneficiary designation on the checking account is inconsistent with the title and/or beneficiary designation selected by the user 112 for the savings account. After processor 132 applies the titling and/or beneficiary designation to the user's 112 savings account, processor 132 may communicate a message to indicate the inconsistency and to ask the user 112 whether the titling and/or beneficiary designation should also be applied to the user's 112 checking account. This question may be presented to user 112 on device 114. User 112 may then use device 114 to indicate to server 110 that the titling and beneficiary designation should also be applied to the user's 112 checking account. In response, processor 132 may then apply the titling and beneficiary designation to the user's 112 checking account.

Although this disclosure describes user 112 changing titles and beneficiary designations in the event of the user's 112 passing, this disclosure contemplates system 100 determining and applying appropriate titles and beneficiary designations in any suitable event. For example, system 100 may detect that user 112 has made a significant purchase, such as a car, and ask user what title and beneficiary designation the user 112 wants to extend to the new purchase. As another example, system 100 may determine that user 112 has gotten married or divorced, and ask user 112 whether user 112 wants to change titles or beneficiary designations to exclude the former spouse or to include the new spouse. As yet another example, system 100 may determine that user 112 has become the parent of a new child and ask user 112 whether user 112 wants to change titles or beneficiary designations to include the new child. System 100 may then change the title or beneficiary designation on an asset to account for any of these events. Similarly, system 100 may help user 112 change title or beneficiary designations on an asset in the event of a death of a beneficiary, co-owner, or any suitable party associated with the asset.

In particular embodiments, system 100 may detect a change of address associated with user 112 and help user 112 appropriately title and designate beneficiaries for an asset based on the change of address. If user 112 moves to a new location with different property laws and estate laws than the property and estate laws under which the asset was titled and the beneficiaries were designated, system 100 may confirm user's 112 new location and proceed to change the title and beneficiaries for the asset. For example, if user 112 had previously included his spouse as a second beneficiary on a checking account, and then user 112 moves to a new location where spouses are required to be primary beneficiaries, system 100 may confirm that user 112 has moved to the new location and then inform user 112 that the new location requires his spouse be a primary beneficiary on the checking account. System 100 may ask user 112 to confirm whether he wants his spouse to be designated as a primary beneficiary on the checking account, and the user 112 may confirm that he wants his spouse to be the primary beneficiary. System 100 may change the designation on the checking account so that the spouse is the primary beneficiary.

In this manner, system 100 may aid user 112 in determining the appropriate titling and/or beneficiary designation for any suitable asset of user 112. User 112 would be able to communicate his desires for an asset by answering questions that use easily understood terminology. In response, the system 100 may determine the appropriate titling and/or beneficiary designations based on the user's 112 responses.

A component of system 100 may include an interface, logic, memory, and/or any other suitable element. An interface receives input, sends output, processes the input and/or output, and/or performs other suitable operations. An interface may comprise hardware and/or software. Logic performs the operations of the component, for example, executes instructions to generate output from input. Logic may include hardware, software, and/or other logic. Logic may be encoded in one or more nontransitory medium, such as a computer readable medium or any other tangible medium, and may perform operations when executed by a computer. Certain logic, such as a processor, may manage the operation of a component. Examples of a processor include one or more computers, one or more microprocessors, one or more applications, and/or other logic.

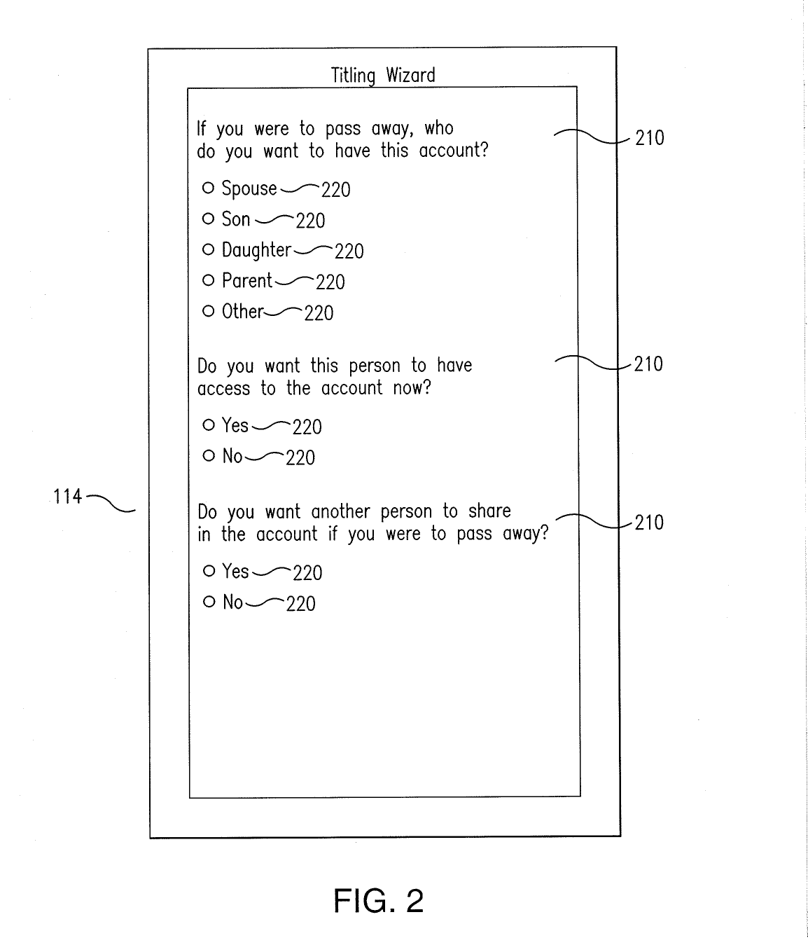

FIGS. 2-5 illustrate the device 114 of system 100. The device 114 may present messages, questions, answer choices, and/or options to user 112. User 112 may use device 114 to interact with other elements of system 100.

FIG. 2 illustrates a device 114 of the system 100 of FIG. 1 that aids in the titling of assets. As provided by FIG. 2, device 114 may display a series of questions 210 and answer choices 220. A user 112 may answer questions 210 so that system 100 may determine the appropriate titling and/or beneficiary designation for an asset.

Device 114 may present on a display questions 210. Questions 210 may have been included in a message 170 from server 110. The questions 210 may pertain to a particular asset of user 112. In the example illustrated in FIG. 2, questions 210 pertain to an account of user 112. For example, the first question 210 asks: “If you were to pass away who do you want to have this account?” The second question 210 asks: “Do you want this person to have access to the account now?” and the third question 210 asks: “Do you want another person to share in the account if you were to pass away?” User 112 may answer these questions 210 in order to communicate his desires for the account. Based on the user's 112 responses to these questions 210, the system 100 may determine the appropriate titling and/or beneficiary designation for the account.

Device 114 may also present, on the display, answer choices 220 for the questions 210. Answer choices 220 may have been received from server 110 in message 170. User 112 may use device 114 to select particular answer choices 220 in response to questions 210. For example, in response to the question 210 “If you were to pass away who do you want to have this account?”, user 112 may select the answer choice 220 “spouse” to indicate that user 112 wants his spouse to have the account after he passes away. After user 112 selects particular answer choices 220, device 114 may communicate these selections to server 110. Server 110 may then use these selections to determine appropriate titling and beneficiary designations for the asset.

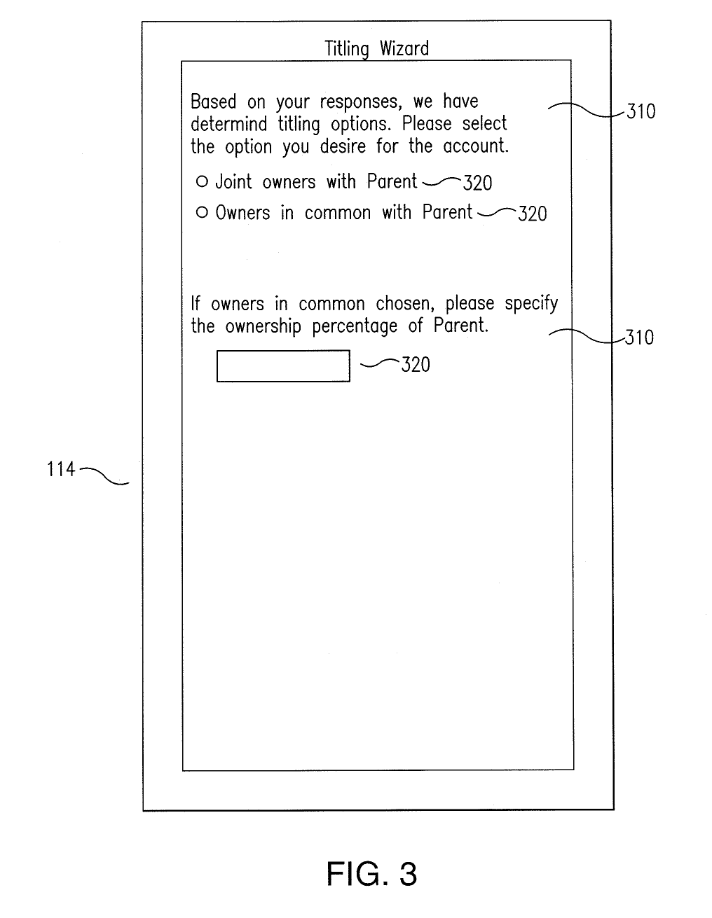

FIG. 3 illustrates a device 114 of the system 100 of FIG. 1 that aids in the titling of assets. As provided by FIG. 3, device 114 may present messages 310 and options 320. The user 112 may use device 114 to select a particular titling option 320 or beneficiary designation 320 in response to a message 310.

Device 114 may present on a display a message 310. Device 114 may have received the message 310 from server 110. In particular embodiments, server 110 may have determined, based on responses that the user 112 supplied, that there are multiple appropriate titling and/or beneficiary designation options. Message 310 may communicate that the system 100 has determined the multiple appropriate titling and/or beneficiary designation options and that the user 112 should select one of these options. In response to the message 310, the user 112 may select a particular option 320.

Device 114 may present on the display the option 320. Options 320 may have been communicated from server 110 along with messages 310. For example, device 114 may have received a message 310 that says “Based on your responses we have determined a number of titling options. Please select the option you desire for the account.” For example, device 114 may have received the options 320: “joint owners with parent” and/or “owners-in-common with parent.” Both options 320 may be appropriate based on the user's responses. For example, the user 112 may have previously indicated that he desires for his parent to have concurrent access to the account. In response, system 100 may determine that making the parent a joint owner or an owner-in-common would serve the desires of user 112. Server 110 may communicate these two options 320 to device 114. In response, device 114 may present these options 320 on the display. User 112 may then use device 114 to select the desired option 320. For example, user 112 may select the option 320 that says “Joint owners with parent” to indicate that user 112 desires to designate his parent as a joint owner of the account. After user 112 makes his desired selections, device 114 may communicate the selections to server 110 so that server 110 may apply the selected titling and/or beneficiary designations to an asset.

In particular embodiments, the option 320 may include a field in which user 112 may provide an answer. For example, a message 310 may state “If owners-in-common chosen, please specify the ownership percentage of parent.” In this case, user 112 may indicate his desire by inputting a percentage ownership in the field. This disclosure contemplates option 320 being a field, dropdown list, a list or any other suitable medium through which to display or input options 320.

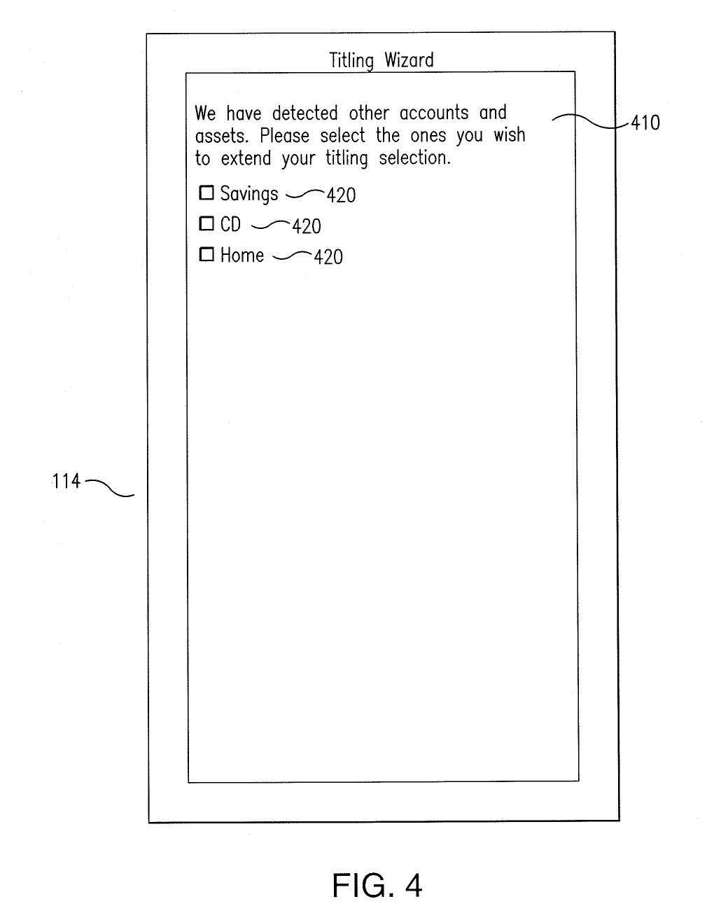

FIG. 4 illustrates a device 114 of the system 100 of FIG. 1 that aids in the titling of assets. As provided in FIG. 4, device 114 may present a message 410 and extension options 420. User 112 may use device 114 to extend titling and/or beneficiary designations to other assets. For example, after server 110 applies the desired titling and/or beneficiary designations to a checking account, server 110 may determine, based on asset information 165, that user 112 also owns a savings account, a CD account, and a home. Server 110 may communicate these other assets to device 114. In response, device 114 may present, on the display, message 410 indicating that the user 112 may extend titling and/or beneficiary designations to other assets. For example, message 410 may read “We have detected other accounts and assets. Please select the ones you wish to extend your titling selection.”

Device 114 may then present extension options 420 corresponding to the other assets. For example, device 114 may present, on the display, extension options 420 for the savings account, the CD account, and the home. User 112 may then select the particular assets to which the desired titling and beneficiary designation may be applied. For example, user 112 may desire to extend the titling and beneficiary designation on the checking account to a savings account. User 112 may select the extension option 420 that says “Savings.” This disclosure contemplates user 112 selecting multiple extension options 420. After user 112 has made his selections, device 114 may communicate the selections to server 110. In response, server 110 may extend the desired titling and beneficiary designation to the selected assets.

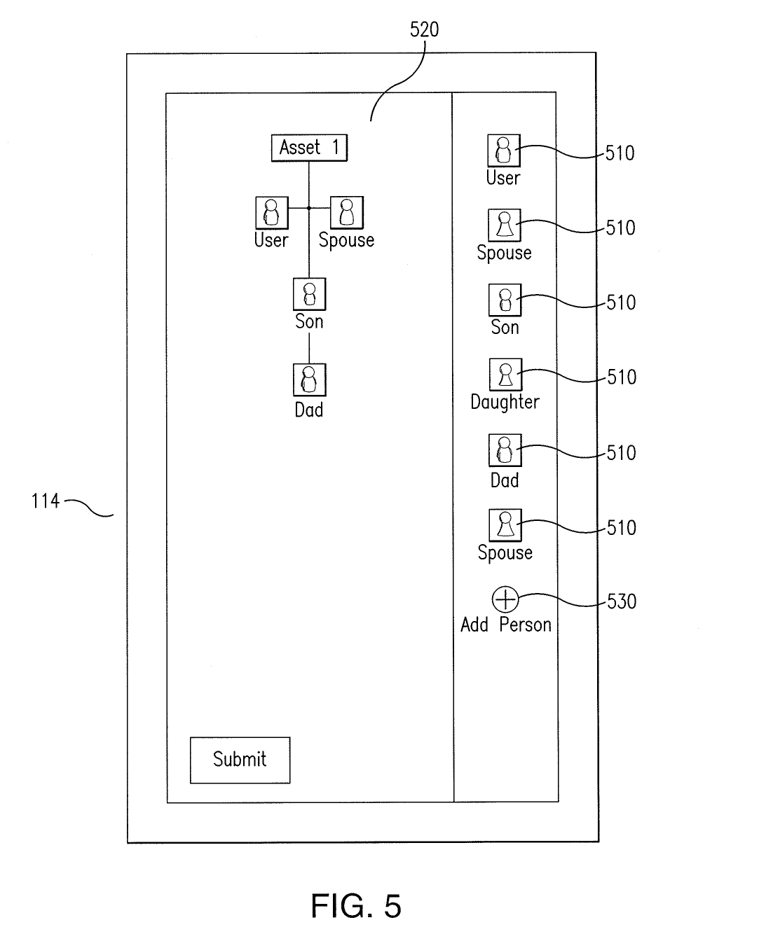

FIG. 5 illustrates a device 114 of the system 100 of FIG. 1 that aids in the titling of assets. As provided in FIG. 5, device 114 may present a graphical interface through which a user 112 may title and designate beneficiaries for an asset. For example, the interface may provide portraits 510 of people to whom the user 112 may wish to associate with the asset. The user 112 may click and drag these portraits into a portion of the interface to build an ownership tree 520 that represents how the asset is to be owned and passed on. In this manner, the user 112 may specify ownership and designate beneficiaries for an asset through a graphical interface that may ease some of the technical and legal challenges associated with preparing titles and designating beneficiaries.

Device 114 may present portraits 510 associated with particular people. In the example illustrated in FIG. 5, device 114 presents portraits 510 of people in user's 112 immediate family, such as a spouse, son, daughter, mother, and father. Server 110 may have retrieved the people and their portraits 510 from user information 155, and server 110 may have communicated the people and their portraits 510 to device 114. User 112 may click and drag a portrait 510 associated with a particular person into an ownership tree 520 to associate that person with an asset.

Device 114 may present an indicator 530 that, when selected, allows user 112 to add a person to the list of people and/or portraits 510. For example, user 112 may wish to add his uncle to the list of people. User 112 may select the indicator 530 and provide input to designate the uncle. For example, user 112 may select the uncle from a listing of people, type in the name of the uncle, and/or perform any other suitable input in order to designate the uncle. After providing the input, the uncle may be added to the list of people, and device 114 may present the uncle along with a portrait 510 in the list of people.

User 112 may build an ownership tree 520 using device 114. The ownership tree 520 may represent the ownership and beneficiaries associated with an asset. In the example illustrated in FIG. 5, the ownership tree 520 represents the ownership and beneficiaries associated with Asset 1. According to the ownership tree 520, user 112 desires for Asset 1 to be jointly owned by user 112 and Spouse. After both user 112 and Spouse pass away, Asset 1 is to be passed on to Son. If Son cannot take Asset 1 at that time or if Son passes away, Asset 1 is to pass onto Dad. User 112 may add a person to the ownership tree 520 by moving that person from the list of people over to a position in the ownership tree 520. For example, user 112 may click and drag Daughter into a position underneath Dad in the ownership tree 520 in order to designate Daughter as the person who takes Asset 1 if Dad passes away. Similarly, user 112 may remove a person from the ownership tree 520 by moving that person from the ownership tree into the list of people. For example, user 112 may click and drag Spouse from the ownership tree 520 to the list of people in order to remove Spouse as a joint owner on Asset 1.

After user 112 has completed building ownership tree 520, user 112 may select the Submit button to submit the ownership tree to system 100. Elements of system 100 may then translate the ownership tree 520 into proper titling and beneficiary designations. In the example illustrated in FIG. 5, after user 112 selects Submit, system 100 may translate the ownership tree 500 so that user 112 and Spouse jointly own Asset 1 and so that Son is the primary beneficiary and Dad is the alternate beneficiary. In this manner, user 112 may use a graphical interface to appropriately title and designate beneficiaries for an asset.

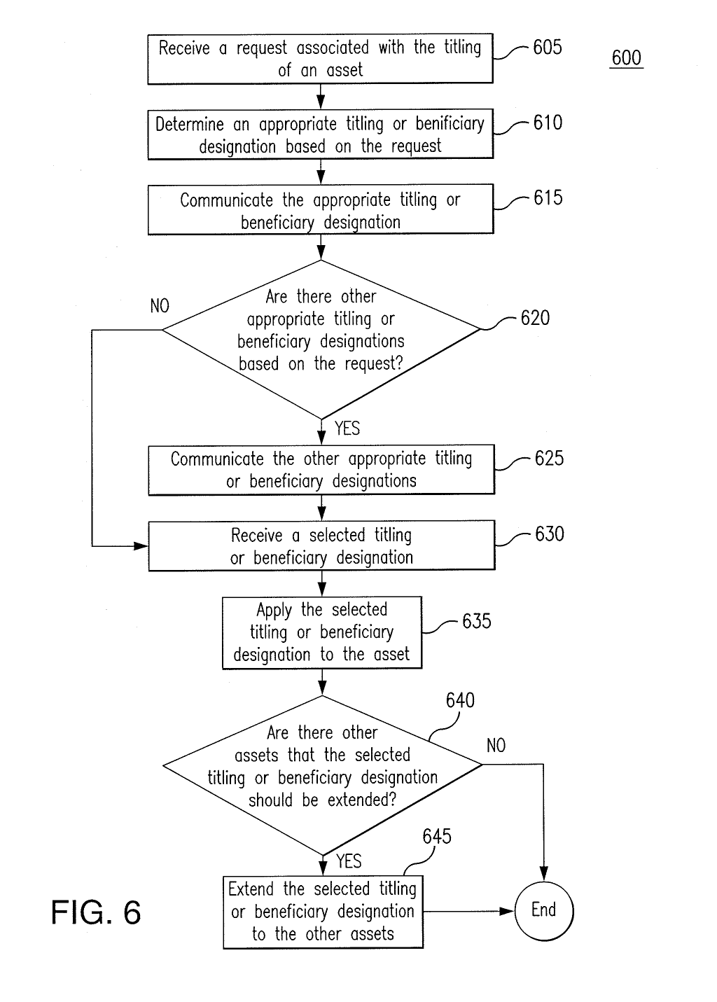

FIG. 6 is a flowchart illustrating a method 600 of titling assets. Server 110 of system 100 may perform method 600. By performing method 600, server 110 may help a user 112 determine the appropriate titling and/or beneficiary designations for an asset.

In step 605, server 110 may receive a request associated with the titling of an asset. The request may include identifiers for user 112, such as a user name, and identifiers associated with an asset, such as an account number. The request may also indicate the user's 112 desires with regards to the asset. For example, the request may include the user's 112 selected answers to questions regarding the asset. Server 110 may have previously communicated the questions and answer choices.

In step 610, server 110 may determine an appropriate titling or beneficiary designation based on the request. For example, if the request indicates that user 112 desires to have his spouse have concurrent access to the account and also to own the account upon the user's 112 passing, server 110 may determine that the appropriate titling for the account is to have the spouse be a joint owner on the account. In step 615, server 110 may communicate the appropriate titling or beneficiary designation. Server 110 may send this communication to device 114. In step 620, server 110 may determine if there are other appropriate titling or beneficiary designations based on the request. If there are no other appropriate titling or beneficiary designations based on the request, server 110 may continue to step 630.

If there are other appropriate titling or beneficiary designations based on the request, server 110 may continue to step 625 to communicate the other appropriate titling or beneficiary designations. For example, server 110 may determine that the user's 112 spouse may also have concurrent access to the account and own the account after the user's 112 passing if the spouse was designated as an owner-in-common on the account. Server 110 may then communicate two options to the user: (1) that the spouse be designated as a joint owner on the account, and (2) that the spouse be designated as an owner-in-common on the account.

In step 630, server 110 may receive a selected titling or beneficiary designation. In instances where only one appropriate titling or beneficiary designation was communicated, server 110 may receive a confirmation of that titling or beneficiary designation. In instances where multiple appropriate titling or beneficiary designations were communicated, server 110 may receive a selection of one or more of those titles or beneficiary designations. In step 635, server 110 may apply the selected titling or beneficiary designation to the asset.

In step 640, server 110 may determine if there are other assets that the selected titling or beneficiary designation should be extended. If there are no other assets to which the selected titling or beneficiary designation may be extended, server 110 may conclude. If there are other assets, server 110 may extend the selected titling or beneficiary designation to the other assets in step 645. In particular embodiments, user 112 may designate the other assets to which the selected titling or beneficiary designation should be extended. For example, server 110 may determine that user 112 owns a second account to which the selected titling or beneficiary designation may be extended. Server 110 may ask user 112 whether the selected titling or beneficiary designation should be extended to the second account. If the user 112 confirms that the selected titling or beneficiary designation should be extended, then server 110 may extend the selected titling or beneficiary designation to the second account.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

1. An apparatus comprising:
a memory operable to store information associated with an asset and information associated with a user; and
a processor communicatively coupled to the memory and operable to:
determine, based at least in part upon the information associated with the user, a first individual related to the user and a second individual related to the user;
transmit a message comprising:
a first request for a designation of who should have access to the asset;
a first answer choice indicating the first individual;
a second request for a designation of who should own the asset upon the user's death; and
a second answer choice indicating the second individual;
receive a response to the message indicating that the first answer choice and the second answer choice were selected;
determine, based at least in part upon the response, that the first individual should be designated as at least one of a joint owner and a tenant in common of the asset;
designate the first individual as at least one of the joint owner and the tenant in common of the asset;
determine, based at least in part upon the response, that the second individual should be designated as a beneficiary of the asset; and
designate the second individual as the beneficiary of the asset.

2. The apparatus of claim 1, wherein the processor is further operable to:
determine a second asset associated with the user;
designate the first individual as at least one of the joint owner and the tenant in common of the second asset; and
designate the second individual as the beneficiary of the second asset.

3. The apparatus of claim 1, wherein the processor is further operable to:
determine that the first individual is not at least one of the joint owner and the tenant in common of a second asset;
determine that the second individual is not the beneficiary of the second asset; and
communicate a message indicating that the first individual is not at least one of the joint owner and the tenant in common of the second asset and that the second individual is not the beneficiary of the second asset.

4. The apparatus of claim 1, wherein the message further comprises a third answer choice indicating a third individual and a fourth answer choice indicating a fourth individual.

5. The apparatus of claim 1, wherein the processor is further operable to:
receive a message indicating that the user has made a purchase;
designate the first individual as at least one of a joint owner and a tenant in common of the purchase; and
designate the second individual as a beneficiary of the purchase.

6. The apparatus of claim 1, wherein the processor is further operable to:
receive a message indicating at least one of a change of address, a birth, a death, a marriage, and a divorce has occurred;
remove, in response to receiving the message, the first individual as the joint owner and the tenant in common of the asset; and
remove, in response to receiving the message, the second individual as the beneficiary of the asset.

7-12. (canceled)

13. A method comprising:
storing, by a memory, information associated with an asset and information associated with a user;
determining, by a processor, based at least in part upon the information associated with the user, a first individual related to the user and a second individual related to the user;
transmitting, by the processor, a message comprising:
a first request for a designation of who should have access to the asset;
a first answer choice indicating the first individual;
a second request for a designation of who should own the asset upon the user's death; and
a second answer choice indicating the second individual;
receiving a response to the message indicating that the first answer choice and the second answer choice were selected;
determining, by the processor, based at least in part upon the response, that the first individual should be designated as at least one of a joint owner and a tenant in common of the asset;
designating, by the processor, the first individual as at least one of the joint owner and the tenant in common of the asset;
determining, by the processor, based at least in part upon the response, that the second individual should be designated as a beneficiary of the asset; and
designating, by the processor, the second individual as the beneficiary of the asset.

14. The method of claim 13 further comprising:
determining, by the processor, a second asset associated with the user;
designating, by the processor, the first individual as at least one of the joint owner and the tenant in common of the second asset; and
designating, by the processor, the second individual as the beneficiary of the second asset.

15. The method of claim 13 further comprising:
determining, by the processor, that the first individual is not at least one of the joint owner and the tenant in common of a second asset;
determining, by the processor, that the second individual is not the beneficiary of the second asset; and
communicating, by the processor, a message indicating that the first individual is not at least one of the joint owner and the tenant in common of the second asset and that the second individual is not the beneficiary of the second asset.

16. The method of claim 13, wherein the message further comprises a third answer choice indicating a third individual and a fourth answer choice indicating a fourth individual.

17. The method of claim 13 further comprising:
receiving, by the processor, a message indicating that the user has made a purchase;
designating, by the processor, the first individual as at least one of a joint owner and a tenant in common of the purchase; and
designating, by the processor, the second individual as a beneficiary of the purchase.

18. The method of claim 13 further comprising:
receiving, by the processor, a message indicating at least one of a change of address, a birth, a death, a marriage, and a divorce has occurred;
removing, by the processor, in response to receiving the message, the first individual as the joint owner and the tenant in common of the asset; and
removing, by the processor, in response to receiving the message, the second individual as the beneficiary of the asset.

19. (canceled)
